(19) United States
(12) Patent Application Publication
(10) Pub. No.: US 2020/0198011 A1
(43) Pub. Date: Jun. 25, 2020

(54) METHOD FOR MANUFACTURING THREE-DIMENSIONAL SHAPED OBJECT

(71) Applicant: SEIKO EPSON CORPORATION, Tokyo (JP)

(72) Inventors: Yasutoshi HIDESHIMA, Matsumoto (JP); Takeshi MIYASHITA, Suwa (JP)

(21) Appl. No.: 16/720,165

(22) Filed: Dec. 19, 2019

(30) Foreign Application Priority Data
Dec. 21, 2018 (JP) 2018-239727

(51) Int. Cl. B22F 3/105; B29C 64/153

(52) U.S. Cl. CPC B22F 3/1055; B33Y 10/00; B29C 64/153

(57) ABSTRACT

A method for manufacturing a three-dimensional shaped object by laminating a layer to manufacture the three-dimensional shaped object, the method including a layer forming step of forming the layer using a constituent material containing amorphous metal powder and a melting and solidifying step of irradiating the layer with a laser to melt and solidify the amorphous metal powder, in which in the melting and solidifying step, a melted and solidified portion obtained by melting and solidifying the amorphous metal powder by being irradiated with the laser is formed and irradiation of the laser is repeated so that at least one-half of a width of the melted and solidified portion overlaps, thereby allowing the layer to become a metal layer in which an amorphous region and a crystal region are formed in a mesh shape.

The present application is based on, and claims priority from JP Application Serial Number 2018-239727, filed Dec. 21, 2018, the disclosure of which is hereby incorporated by reference herein in its entirety.

### BACKGROUND

### 1. Technical Field

The present disclosure relates to a method for manufacturing a three-dimensional shaped object.

### 2. Related Art

In the related art, various methods for manufacturing the three-dimensional shaped object are used. Among the methods, there is a method for manufacturing a three-dimensional shaped object by laminating layers to manufacture the three-dimensional shaped object. For example, JP-T-2010-505041 discloses a method for manufacturing a three-dimensional shaped object by laminating layers to manufacture the three-dimensional shaped object whose whole or selected portion is made of amorphous metal.

In recent years, it is desired to manufacture a three-dimensional shaped object having high hardness and high toughness. However, in the three-dimensional shaped object whose entirety or selected portion is simply made of amorphous metal as described in JP-T-2010-505041, sufficiently high hardness and sufficiently high toughness may not be obtained in some cases.

### SUMMARY

A method for manufacturing a three-dimensional shaped object according to an aspect of the present disclosure is a method for manufacturing a three-dimensional shaped object by laminating a layer to manufacture the three-dimensional shaped object, the method including a layer forming step of forming the layer using a constituent material containing amorphous metal powder and a melting and solidifying step of irradiating the layer with a laser to melt and solidify the amorphous metal powder, in which in the melting and solidifying step, a melted and solidified portion obtained by melting and solidifying the amorphous metal powder by being irradiated with the laser is formed and irradiation of the laser is repeated so that at least one-half of a width of the melted and solidified portion overlaps, thereby allowing the layer to become a metal layer in which an amorphous region and a crystal region are formed in a mesh shape.

### BRIEF DESCRIPTION OF THE DRAWINGS

FIG. 1 is a schematic configuration diagram illustrating an example of a three-dimensional shaped object manufacturing apparatus capable of executing a method for manufacturing a three-dimensional shaped object according to an embodiment of the present disclosure.

FIG. 2 is a schematic configuration diagram illustrating an example of another three-dimensional shaped object manufacturing apparatus capable of executing the method for manufacturing the three-dimensional shaped object according to the embodiment of the present disclosure.

FIG. 3 is a flowchart of the method for manufacturing the three-dimensional shaped object according to the embodiment of the present disclosure.

FIG. 4 is a cross-sectional view of a layer for describing a melted and solidified portion in which an amorphous region and a crystal region are formed with laser irradiation in the method for manufacturing the three-dimensional shaped object according to the embodiment of the present disclosure.

FIG. 5 is a cross-sectional view of a layer for describing how the amorphous region and the crystal region are formed in a mesh shape by repeating laser irradiation for a plurality of lines in the method for manufacturing the three-dimensional shaped object according to the embodiment of the present disclosure.

FIG. 6 is a photograph of a three-dimensional shaped object configured by executing the method for manufacturing the three-dimensional shaped object according to the embodiment of the present disclosure.

FIG. 7 is a schematic diagram of the photograph of the three-dimensional shaped object of FIG. 6.

FIG. 8 is a conceptual diagram of a three-dimensional shaped object configured by laminating layers by executing the method for manufacturing the three-dimensional shaped object according to the embodiment of the present disclosure.

FIG. 9 is a conceptual diagram illustrating an example of a moving direction of an irradiation position of a laser of the N-th layer and the moving direction of the irradiation position of the laser of the (N+1)-th layer in the method for manufacturing the three-dimensional shaped object according to the embodiment of the present disclosure.

FIG. 10 is a conceptual diagram illustrating an example of the moving direction of the laser irradiation position of the N-th layer, the moving direction of the laser irradiation position of the (N+1)-th layer, and the moving direction of the laser irradiation position of the (N+2)-th layer in the method for manufacturing the three-dimensional shaped object according to the embodiment of the present disclosure.

FIG. 11 is a conceptual diagram illustrating another example of the moving direction of the laser irradiation position of the N-th layer in the method for manufacturing the three-dimensional shaped object according to the embodiment of the present disclosure.

FIG. 12 is a conceptual diagram illustrating still another example of the moving direction of the laser irradiation position of the N-th layer in the method for manufacturing the three-dimensional shaped object according to the embodiment of the present disclosure.

### DESCRIPTION OF EXEMPLARY EMBODIMENTS

First, the present disclosure will be schematically described.

According to a first aspect of the present disclosure, there is provided a method for manufacturing a three-dimensional shaped object by laminating a layer to manufacture the three-dimensional shaped object, the method including a layer forming step of forming the layer using a constituent material containing amorphous metal powder and a melting and solidifying step of irradiating the layer with a laser to melt and solidify the amorphous metal powder, in which in the melting and solidifying step, a melted and solidified portion obtained by melting and solidifying the amorphous metal powder by being irradiated with the laser is formed and irradiation of the laser is repeated so that at least one-half of a width of the melted and solidified portion overlaps, thereby allowing the layer to become a metal layer in which an amorphous region and a crystal region are formed in a mesh shape.

According to the first aspect, the metal layer in which the amorphous region and the crystal region are formed in a mesh shape is formed by forming the melted and solidified portion obtained by melting and solidifying the amorphous metal powder by being repeatedly irradiated with the laser so that at least one-half of a width of the melted and solidified portion overlaps. For that reason, since the metal layer in which the amorphous region and the crystal region are surely formed in a mesh shape is formed, the manufactured three-dimensional shaped object can be made to have high hardness and high toughness.

A second aspect of the present disclosure provides the method for manufacturing the three-dimensional shaped object according to the first aspect, in which, in the melting and solidifying step, the amorphous metal powder in the layer is continuously melted by continuously moving an irradiation position of the laser to the layer.

According to the second aspect, since the amorphous metal powder in the layer is continuously melted by continuously moving the irradiation position of the laser to the layer, the amorphous metal powder can be melted at high speed using a laser irradiation device having a simple configuration.

A third aspect of the present disclosure provides the method for manufacturing the three-dimensional shaped object according to the second aspect, in which a movement path of the irradiation position of the laser to an N-th layer and a movement path of the irradiation position of the laser to an (N+1)-th layer are different from each other when viewed from a lamination direction.

According to the third aspect, since the movement path of the irradiation position of the laser to the N-th layer and the movement path of the irradiation position of the laser to the (N+1)-th layer are different from each other in the lamination direction, a metal layer having high hardness and high toughness can be obtained even in the lamination direction.

A fourth aspect of the present disclosure provides the method for manufacturing the three-dimensional shaped object according to the third aspect, in which a moving direction of the irradiation position of the laser to the N-th layer and a moving direction of the irradiation position of the laser to the (N+1)-th layer intersect each other when viewed from the lamination direction.

According to the fourth aspect, since the moving direction of the irradiation position of the laser to the N-th layer and the moving direction of the irradiation position of the laser to the (N+1)-th layer intersect each other when viewed from the lamination direction, a metal layer having high hardness and high toughness can be obtained even in the lamination direction.

A fifth aspect of the present disclosure provides the method for manufacturing the three-dimensional shaped object according to the third aspect, in which a moving direction of the irradiation position of the laser to the N-th layer and a moving direction of the irradiation position of the laser to the (N+1)-th layer are the same direction when viewed from the lamination direction and are shifted by one-half of the width of the melted and solidified portion.

According to the fifth aspect, since the moving direction of the irradiation position of the laser to the N-th layer and the moving direction of the irradiation position of the laser to the (N+1)-th layer are the same direction when viewed from the lamination direction and are shifted by one-half of the width of the melted and solidified portion, a metal layer having high hardness and high toughness can be obtained even in the lamination direction.

A sixth aspect of the present disclosure provides the method for manufacturing the three-dimensional shaped object according to the third aspect, in which a shape of the movement path of the irradiation position of the laser to the N-th layer and a shape of the movement path of the irradiation position of the laser to the (N+1)-th layer are different from each other when viewed from the lamination direction.

According to the sixth aspect, since the shape of the movement path of the irradiation position of the laser to the N-th layer and the shape of the movement path of the irradiation position of the laser to the (N+1)-th layer are different from each other when viewed from the lamination direction, a metal layer having high hardness and high toughness can be obtained even in the lamination direction.

A seventh aspect of the present disclosure provides the method for manufacturing the three-dimensional shaped object according to the sixth aspect, in which one of a shape of the movement path of the irradiation position of the laser to the N-th layer and a shape of the movement path of the irradiation position of the laser to the (N+1)-th layer is linear and the other is curved when viewed from the lamination direction.

According to the seventh aspect, one of the shape of the movement path of the irradiation position of the laser to the N-th layer and the shape of the movement path of the irradiation position of the laser to the (N+1)-th layer is linear and the other is curved when viewed from the lamination direction. For that reason, the shape of the movement path of the irradiation position of the laser of the N-th layer and the shape of the movement path of the irradiation position of the laser of the (N+1)-th layer can be easily made different from each other in the lamination direction.

Hereinafter, embodiments according to the present disclosure will be described with reference to the accompanying drawings.

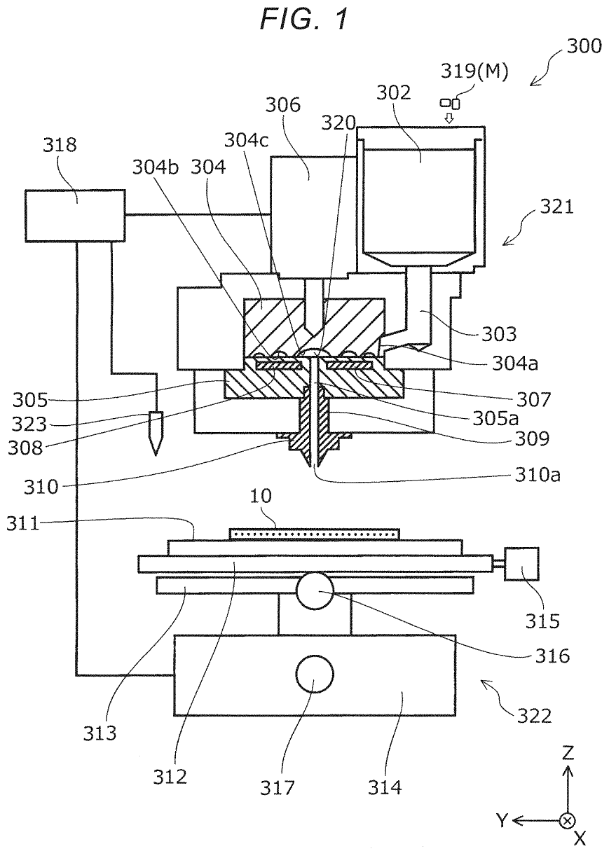

First, an outline of a three-dimensional shaped object manufacturing apparatus 300 capable of executing a method for manufacturing a three-dimensional shaped object of the present disclosure will be described with reference to FIG. 1.

Here, the X-direction in the figure is a horizontal direction, the Y-direction is a horizontal direction and a direction orthogonal to the X-direction, and the Z-direction is a vertical direction. A “three-dimensional shaping” in the present specification indicates forming a so-called three-dimensional shaped object and includes forming a shape having a thickness even if the shape is a so-called two-dimensional shape, such as a flat shape, for example, a shape configured by one layer.

As illustrated in FIG. 1, the three-dimensional shaped object manufacturing apparatus 300 includes a hopper 302 that accommodates pellets 319 as a constituent material M constituting the three-dimensional shaped object. Here, the pellets 319 as the constituent material M contain amorphous metal powder. Examples of the amorphous metal powder include (Fe, Co, Ni)—Si—B based amorphous metal powder, (Fe, Co, Ni)—(Nb, Zr) based amorphous metal powder, and the like. The pellets 319 accommodated in the hopper 302 are supplied to a circumferential surface 304a of a substantially cylindrical flat screw 304 through a supply path 303.

On the bottom surface of the flat screw 304, a spiral notch 304b extending from the circumferential surface 304a to a central portion 304c is formed. For that reason, the pellets 319 are sent from the circumferential surface 304a to the central portion 304c by rotating the flat screw 304 with a motor 306 in a direction along the Z-direction as a rotation axis.

A barrel 305 is provided at a position facing the bottom surface of the flat screw 304 with a predetermined interval. A heater 307 and a heater 308 are provided in the vicinity of the top surface of the barrel 305. Since the flat screw 304 and the barrel 305 have such a configuration, by rotating the flat screw 304, the pellets 319 are supplied to a space portion 320 formed by the notch 304b formed between the bottom surface of the flat screw 304 and the top surface of the barrel 305 and move from the circumferential surface 304a to the central portion 304c. When the pellets 319 move through the space portion 320 by the notch 304b, the pellets 319 are melted and plasticized by heat of the heater 307 and the heater 308, and are pressurized with pressure accompanying movement of the pellets 319 through the narrow space portion 320. In this way, the pellets 319 are plasticized, and thus the constituent material M having fluidity is injected from a nozzle 310a.

A movement path 305a of the constituent material M, which is the melted pellet 319, is formed in the center portion of the barrel 305 in plan view. The movement path 305a is connected to the nozzle 310a of an injection portion 310 that injects the constituent material M.

The injection portion 310 is configured to continuously inject the constituent material M in a fluid state from the nozzle 310a. The injection portion 310 is provided with a heater 309 for maintaining the plasticized state of the constituent material M. The constituent material M injected from the injection portion 310 is injected in a linear shape. Then, a layer 10 of the constituent material M is formed by injecting the constituent material M linearly from the injection portion 310.

In the three-dimensional shaped object manufacturing apparatus 300 of FIG. 1, an injection unit 321 is formed by the hopper 302, the supply path 303, the flat screw 309, the barrel 305, the motor 306, the injection portion 310, and the like. Although the three-dimensional shaped object manufacturing apparatus 300 of this embodiment is configured to include one injection unit 321 that injects the constituent material M, the three-dimensional shaped object manufacturing apparatus 300 may be configured to include a plurality of injection units 321 that inject the constituent material M.

The three-dimensional shaped object manufacturing apparatus 300 includes a stage unit 322 for placing the layer 10 formed by being injected from the injection unit 321. The stage unit 322 includes a plate 311 on which the layer 10 is actually placed. The stage unit 322 includes a first stage 312 on which the plate 311 is placed and whose position can be changed along the Y-direction by driving a first driving unit 315. The stage unit 322 includes a second stage 313 on which the first stage 312 is mounted and whose position can be changed along the X-direction by driving a second driving unit 316. The stage unit 322 includes a base portion 314 that can change the position of the second stage 313 along the Z-direction by driving a third driving unit 317.

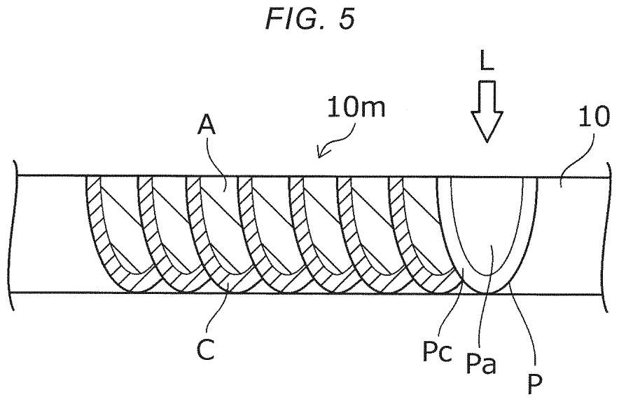

The three-dimensional shaped object manufacturing apparatus 300 includes a galvanometer laser 323 and is configured to be able to irradiate the layer 10 placed on the plate 311 with a laser L (see FIG. 5). The galvanometer laser 323 includes a laser irradiation unit, a plurality of mirrors for positioning the laser from the laser irradiation unit, and a lens that converges the laser L, and is configured to be able to scan the laser L at high speed and in a wide range.

The three-dimensional shaped object manufacturing apparatus 300 is electrically connected to a control unit 318 that controls various driving of the injection unit 321, various driving of the stage unit 322, driving of the galvanometer laser 323, and the like.

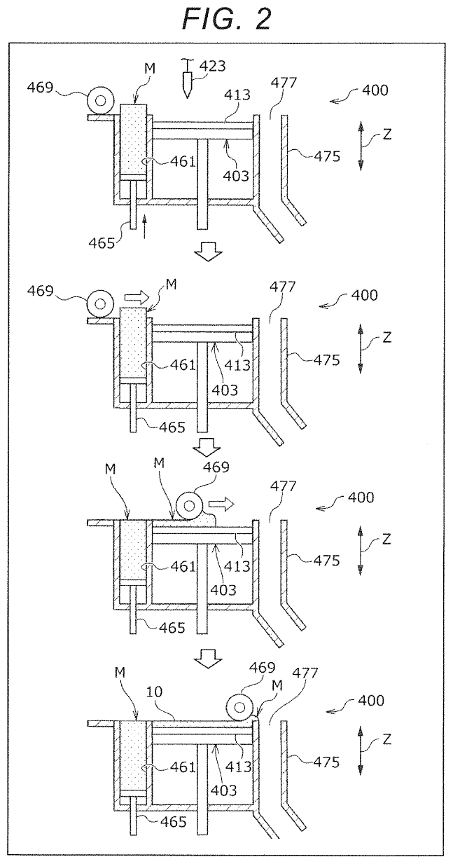

Next, an overview of a three-dimensional shaped object manufacturing apparatus 400 according to the present disclosure capable of executing the method for manufacturing the three-dimensional shaped object and having a configuration different from that of the three-dimensional shaped object manufacturing apparatus 300 of FIG. 1 will be described with reference to FIG. 2. FIG. 2 is represented by four state diagrams so that an operation of the three-dimensional shaped object manufacturing apparatus 400 can be understood. The Z-direction in this figure is the vertical direction.

The three-dimensional shaped object manufacturing apparatus 400 illustrated in FIG. 2 includes a cylinder chamber 461 that accommodates the constituent material M having fluidity on a side of a stage 403, and the cylinder chamber 461 includes a piston 465 that can move up and down in the Z-direction. Here, the constituent material M contains amorphous metal powder. As illustrated in the top state diagram in FIG. 2, on the upper left side of the cylinder chamber 461 in FIG. 2, a coating roller 469 for supplying the constituent material M onto a layer formation region 413 on the stage 403 or the formed layer 10 to form a coating film having a predetermined thickness is disposed. Then, the coating roller 469 is configured to be able to move in a range from the position illustrated in the top state diagram in FIG. 2 and the second state diagram from the top in FIG. 2 to a position facing a recovery port 477 on the upper side of a recovery chute 475 on the right side in FIG. 2 through the layer formation region 413 on the stage 403 as illustrated in the third state diagram from the top in FIG. 2 and the bottom state diagram in FIG. 2.

In FIG. 2, a galvanometer laser 423 is omitted except for the top state diagram in FIG. 2, but the galvanometer laser 423 having the same configuration as the galvanometer laser 323 of the three-dimensional shaped object manufacturing apparatus 300 in FIG. 1 is provided in the three-dimensional shaped object manufacturing apparatus 400.

Here, a flow of manufacturing the three-dimensional shaped object in the three-dimensional shaped object manufacturing apparatus 400 will be described.

When manufacturing the three-dimensional shaped object using the three-dimensional shaped object manufacturing apparatus 400, an operation proceeds in the order of preparation of the constituent material M, coating of the constituent material M, and melting of the constituent material M. The contents of these operations will be described below.

First, in preparing a composition having fluidity, the cylinder chamber 461 is filled with a necessary amount of the constituent material M. Next, as illustrated in the top state diagram in FIG. 2 and the second state diagram from the top in FIG. 2, the piston 465 is moved upward by a predetermined amount necessary for forming the layer 10 for one layer. The stage 403 is set to predetermined height when the layer 10 for one layer is formed, and the coating roller 469 is positioned at the position represented by the top state diagram in FIG. 2 and the second state diagram from the top in FIG. 2.

Next, in coating the constituent material M, the coating roller 469 is moved from the position illustrated in the top state diagram in FIG. 2 and the second state diagram from the top in FIG. 2, to the stage 403 side, as illustrated in the third state diagram from the top in FIG. 2. In this case, the coating roller 469 scrapes the constituent material M of the portion protruding from the top surface of the cylinder chamber 461 to reach the stage 403 and fills the stage 403 with the constituent material M as illustrated in the third state diagram from the top in FIG. 2 and the bottom state diagram in FIG. 2. The coating roller 469 moves to a position facing the recovery port 477 on the upper side of the recovery chute 475 on the right side in FIG. 2 of the layer formation region 413 on the stage 403 and discharges the surplus constituent material M to the recovery chute 475.

Next, in melting the constituent material M, the coating roller 469 is retracted from the position on the layer formation region 413 to the position illustrated in the top state diagram in FIG. 2 and the second state diagram from the top in FIG. 2, and the constituent material M in a region corresponding to the three-dimensional shaped object in the layer 10 is melted using the galvanometer laser 423.

Then, a desired three-dimensional shaped object is manufactured by laminating the layer 10 configured by preparing the constituent material M, coating the constituent material M, and melting the constituent material M.

The three-dimensional shaped object manufacturing apparatus capable of executing the method for manufacturing the three-dimensional shaped object according to the present disclosure is not limited to a flat screw type such as the three-dimensional shaped object manufacturing apparatus 300 or a powder bed fusion type such as the three-dimensional shaped object manufacturing apparatus 400 described above. As the three-dimensional shaped object manufacturing apparatus, for example, an apparatus using a dispenser as injection means, a material extrusion type using a filament as a material form, or the like can be used.

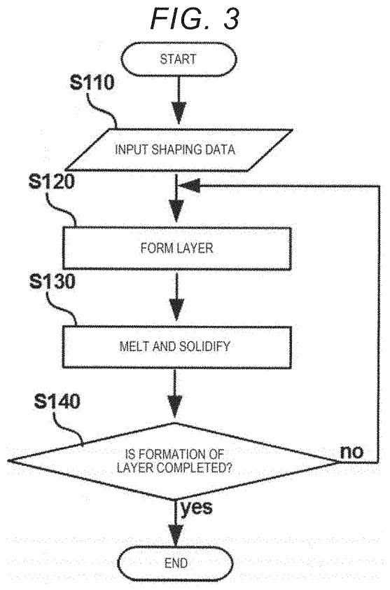

Next, one embodiment of the method for manufacturing the three-dimensional shaped object using the three-dimensional shaped object manufacturing apparatus 300 or the three-dimensional shaped object manufacturing apparatus 400 will be described with reference to the flowchart of FIG. 3 and FIGS. 4 to 12.

In the method for manufacturing the three-dimensional shaped object according to this embodiment, first, as illustrated in the flowchart of FIG. 3, shaping data of a three-dimensional shaped object to be manufactured is input in a shaping data input process of step S110. Although an input source of the shaping data of the three-dimensional shaped object is not particularly limited, the shaping data can be input to the three-dimensional shaped object manufacturing apparatus using a PC or the like.

Next, in a layer forming step of step S120, the layer 10 is formed on the plate 311 on the first stage 312 or the layer formation region 413 on the stage 403 using the constituent material M containing amorphous metal powder. Examples of the amorphous metal powder include (Fe, Co, Ni)—Si—B based amorphous metal powder, (Fe, Co, Ni)—(Nb, Zr) based amorphous metal powder, and the like.

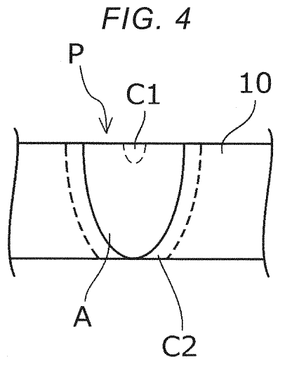

Next, in a melting and solidifying process of step S130, as illustrated in FIG. 4, the layer 10 is irradiated with the laser L to melt the amorphous metal powder contained in the layer 10. Here, in this step, a case where a melted and solidified portion P (amorphous region A, crystal region C1, and crystal region C2) is formed when the laser L is focused on a predetermined region and the predetermined region is irradiated with the laser L is illustrated.

After reaching a melting temperature, the melted and solidified portion P is solidified as the temperature of the irradiated region decreases when laser irradiation is completed, but, since a cooling rate is sufficiently fast, the amorphous region A is formed. On the other hand, at the central portion of the irradiation region, the crystal region C1 is formed because the cooling rate is slow. Even if the metal powder before irradiation with the laser L is amorphous, the crystal region C2 is formed around the melted and solidified portion P because the crystal region C2 is heated to a crystallization temperature region.

Of the heated and melted region by laser irradiation, at a region where the cooling rate is faster than a heat transfer rate from the melted region to the peripheral region, when metal atoms move and solidify at a fast speed that is not in time to become a crystalline state, the amorphous region A is formed. On the other hand, the reason why the center of the region heated and melted by the laser irradiation becomes the crystal region C1 is that, when melted and solidified, heat transfer from the periphery of the melted portion is small and the cooling rate is slow. The reason why the periphery of the melted and solidified portion P becomes the crystal region C2 is that the temperature is raised to a crystallization temperature by heating with laser irradiation.

In the melting and solidifying, the first stage 312 or the stage 403 may be locally cooled and solidified.

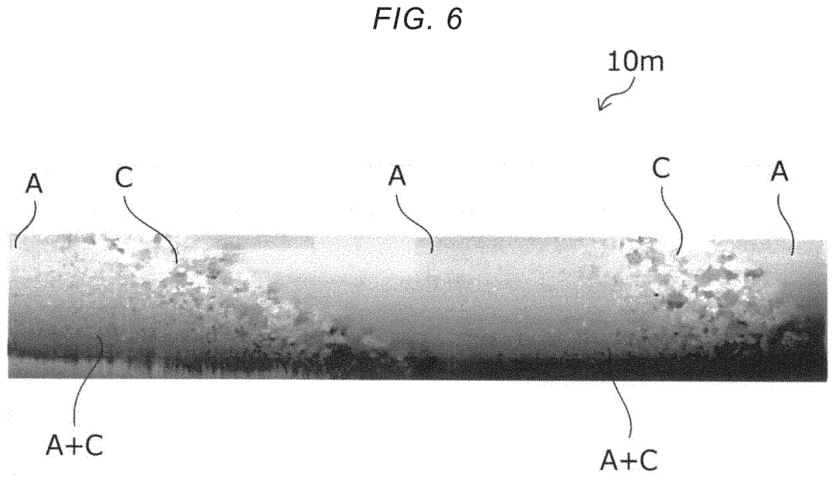

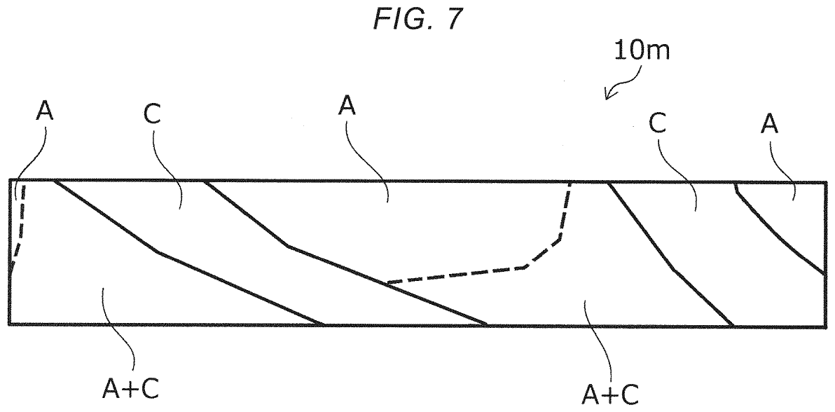

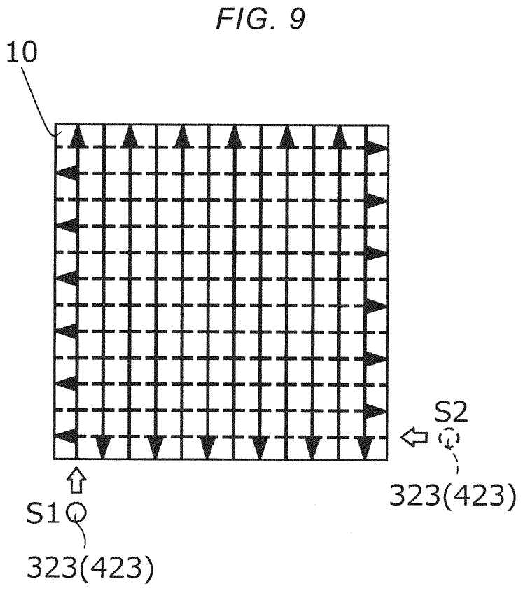

In this step, the amorphous metal powder in the layer is continuously melted by continuously moving the irradiation position of the laser L onto the layer 10 in a line, for example, as illustrated by the solid arrow in FIG. 9. Here, FIGS. 4 and 5 are cross-sectional views of the layer 10 when viewed from the moving direction of the irradiation position of the laser L. Then, as illustrated in FIG. 5, by repeating the irradiation of the laser L so that at least one-half of the width of the melted and solidified portion P overlaps, the layer 10 becomes a metal layer 10m in which the amorphous region A and the crystal region C are formed in a mesh shape. Here, FIG. 6 is a photograph of a part of the metal layer 10m in FIG. 5, and FIG. 7 is a schematic diagram corresponding to the photograph of FIG. 6 and describing the photograph of FIG. 6. In FIGS. 6 and 7, although a region (A+C) in which metal in a partially crystalline state is mixed with metal in an amorphous state is formed, in this specification, such a region is also regarded as the amorphous region A.

As described above, since FIGS. 4 and 5 are cross-sectional views of the layer 10 when viewed from the moving direction of the irradiation position of the laser L, the moving direction of the continuous irradiation position of the laser L in FIGS. 4 and 5 is a direction perpendicular to the paper surface. Although the irradiation position of the laser L on the layer 10 may be moved intermittently while irradiating the layer 10 of the laser L with a spot, even when the irradiation position of the laser L on the layer 10 is moved intermittently, the layer 10 can become the metal layer 10m in which the amorphous region A and the crystal region C are formed in a mesh shape by repeating irradiation of the laser L so that each irradiation position overlaps at least one-half of the width of the melted and solidified portion P.

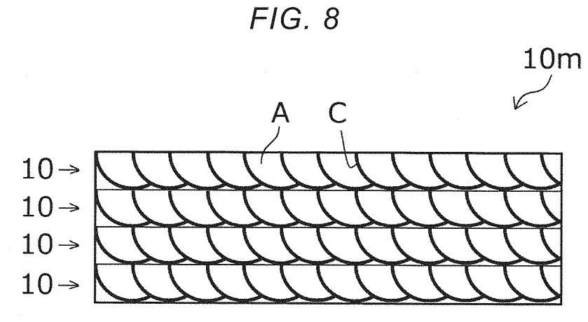

In step S140, it is determined whether or not formation of the layer 10 based on the shaping data input in step S110 is completed. When it is determined that the formation of the layer 10 is not completed, that is, when it is determined that the layer 10 is to be laminated further, the process returns to step S120 and the next layer 10 is formed. On the other hand, when it is determined that the formation of the layer 10 is completed, the method for manufacturing the three-dimensional shaped object according to this embodiment is ended. FIG. 8 illustrates a state in which steps S120 to S140 are repeated four times. As illustrated in FIG. 8, the three-dimensional shaped object formed by the method for manufacturing the three-dimensional shaped object according to this embodiment is the metal layer 10m in which the amorphous region A and the crystal region C are formed in a mesh shape also in the lamination direction.

In the method for manufacturing the three-dimensional shaped object according to this embodiment, the movement path of the laser L in plan view can be changed in each layer 10 in the lamination direction. For example, as illustrated in FIG. 9, the layer 10 of the N-th layer in the lamination direction can be irradiated with the laser L one line at a time in order from an initial position S1 along the solid line arrow and the layer 10 of the (N+1)-th layer in the lamination direction can be irradiated with the laser L one line at a time in order from an initial position S2 along the broken line arrow which is shifted by 90° with respect to the solid line arrow. Then, the laminated metal layer 10m can be formed by repeatedly irradiating the (N+2)-th layer with the laser L in the same manner as the N-th layer and the (N+3)-th layer in the same manner as the (N+1)-th layer.

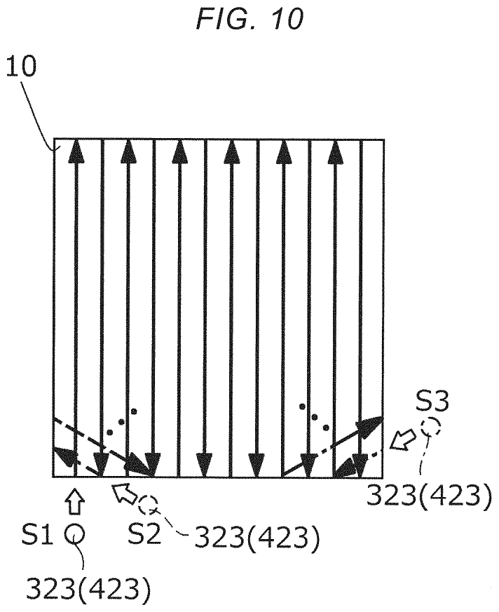

As illustrated in FIG. 10, the layer 10 of the N-th layer in the lamination direction can be irradiated with the laser L one line at a time in order from the initial position S1 along the solid line arrow, the layer 10 of the (N+1)-th layer in the lamination direction can be irradiated with the laser L one line at a time in order from the initial position S2 along the broken line arrow which is shifted by 60° with respect to the solid line arrow, and the layer 10 of the (N+2)-th layer in the lamination direction can be irradiated with the laser L one line at a time in order from an initial position S3 along the one-dot chain line arrow which is shifted by 120° with respect to the solid line arrow. Then, the laminated metal layer 10m can be formed by repeatedly irradiating the (N+3)-th layer with the laser L in the same manner as the N-th layer, and the (N+4)-th layer in the same manner as the (N+1)-th layer, and the (N+5)-th layer in the same manner as the (N+2)-th layer. In FIG. 10, for the sake of easy understanding, a part of the broken arrow of the (N+1)-th layer and the one-dot chain line of the (N+2)-th layer are partially omitted.

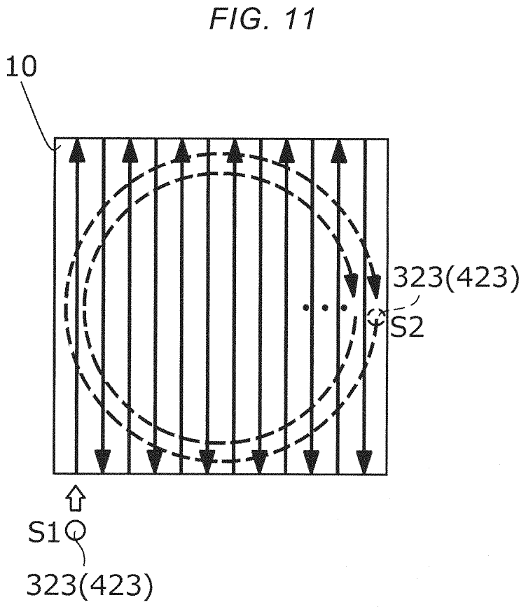

As illustrated in FIG. 11, the layer 10 of the N-th layer in the lamination direction can be irradiated with the laser L one line at a time in order from the initial position S1 along the solid line arrow and the layer 10 of the (N+1) -th layer in the lamination direction can be irradiated with the laser L one arc at a time in order from the initial position S2 along the broken line arrow so as to draw an arc. Then, the laminated metal layer 10m can be formed by repeatedly irradiating the (N+2)-th layer with the laser L in the same manner as the N-th layer and the (N+3)-th layer in the same manner as the (N+1)-th layer. In FIG. 11, for the sake of easy understanding, apart of the broken arrow of the (N+1)-th layer is partially omitted.

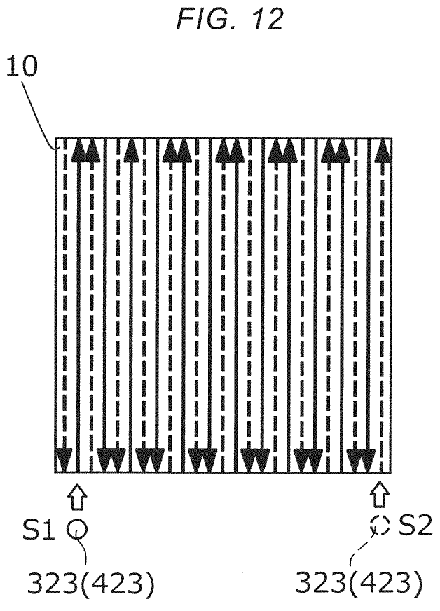

Furthermore, as illustrated in FIG. 12, the layer 10 of the N-th layer in the lamination direction can be irradiated with the laser L one line at a time in order from the initial position S1 along the solid line arrow and the layer 10 of the (N+1)-th layer in the lamination direction can be irradiated with the laser L one line at a time in order from the initial position S2 along the broken line arrow that is shifted by one-half pitch in the same moving direction with respect to the solid line arrow. Then, the laminated metal layer 10m can be formed by repeatedly irradiating the (N+2) -th layer with the laser L in the same manner as the N-th layer and the (N+3)-th layer in the same manner as the (N+1)-th layer.

Here, when summarizing the method for manufacturing the three-dimensional shaped object of this embodiment, the method for manufacturing the three-dimensional shaped object of this embodiment is a manufacturing method of a three-dimensional shaped object by manufacturing a three-dimensional shaped object by laminating the layers 10. The method for manufacturing the three-dimensional shaped object of this embodiment includes a layer forming step of forming the layer 10 using the constituent material M containing amorphous metal powder corresponding to step S120 and a melting and solidifying step of melting and solidifying the amorphous metal powder by irradiating the layer 10 with the laser L corresponding to step S130. Here, in the melting and solidifying step of step S130, as described above, the melted and solidified portion P obtained by melting and solidifying the amorphous metal powder by being irradiated with the laser L is formed and irradiation of the laser L is repeated so that at least one-half of the width of the melted and solidified portion P overlaps, thereby allowing the layer 10 to become the metal layer 10m in which the amorphous region A and the crystal region C are formed in a mesh shape.

As such, by executing the method for manufacturing the three-dimensional shaped object according to this embodiment, the metal layer 10m in which the amorphous region A and the crystal region C are surely formed in a mesh shape is formed, and thus the manufactured three-dimensional shaped object can be made to have high hardness and high toughness. In the irradiation examples of the laser L illustrated in FIGS. 9 to 12, irradiation of the laser L is repeated so that one-half of the width of the melted and solidified portion P overlaps. However, when it is desired to increase toughness, a portion more than one-half of the width of the melted and solidified portion P may overlap. Usually, in the case of amorphous powder, the crystal region C1 is often formed at the center of the melted and solidified portion P, and it is prescribed that one-half of the width overlaps, but the crystal region C1 may not be formed at the center of the melted and solidified portion P, for example, when the amorphous powder is easily amorphized or when the scanning speed of the laser L is high. In that case, the irradiation of the laser L may be repeated so that, for example, one-fourth of the width overlaps so that a portion less than one-half of the width of the melted and solidified portion P overlaps.

In the method for manufacturing the three-dimensional shaped object of this embodiment, the amorphous metal powder in the layer 10 is continuously melted by continuously moving the irradiation position of the laser L to the layer 10 in the melting and solidifying step of step S130. For that reason, in the method for manufacturing the three-dimensional shaped object according to this embodiment, the amorphous metal powder can be melted at a high speed using the laser L irradiation device having a simple configuration such as a galvanometer laser.

As described above, in the method for manufacturing the three-dimensional shaped object of this embodiment, as illustrated in FIGS. 9 to 12, the movement path of the irradiation position of the laser L of the N-th layer and the movement path of the irradiation position of the laser L of the (N+1)-th layer can be made different from each other when viewed from the lamination direction. For that reason, the metal layer 10m of high hardness and toughness can be obtained also in the lamination direction by executing the method for manufacturing the three-dimensional shaped object according to this embodiment. This is because regularity of a mesh structure of the amorphous region A and the crystal region C in the lamination direction can be reduced and formation of a brittle portion in the metal layer 10m can be suppressed.

As illustrated in FIGS. 9 and 10, in the method for manufacturing the three-dimensional shaped object according to this embodiment, the moving direction of the irradiation position of the laser L of the N-th layer and the moving direction of the irradiation position of the laser L of the (N+1)-th layer can be crossed when viewed from the lamination direction. For that reason, the metal layer 10m of high hardness and toughness can be obtained also in the lamination direction by executing the method for manufacturing the three-dimensional shaped object according to this embodiment.

As illustrated in FIG. 12, in the method for manufacturing the three-dimensional shaped object according to this embodiment, the moving direction of the irradiation position of the laser L of the N-th layer and the moving direction of the irradiation position of the laser L of the (N+1)-th layer are set to the same direction when viewed from the lamination direction, and one-half of the width of the melted and solidified portion P can be shifted. For that reason, the metal layer 10m of high hardness and toughness can be obtained also in the lamination direction by executing the method for manufacturing the three-dimensional shaped object according to this embodiment. The “shifting by one-half of the width of the melted and solidified portion P” means that in a strict sense, the width of the melted and solidified portion P does not need to be shifted by one-half of the width and it is sufficient that the width of the melted and solidified portion P is shifted approximately by one-half of the width.

As illustrated in FIG. 11, in the method for manufacturing the three-dimensional shaped object according to this embodiment, the shape of the movement path of the irradiation position of the laser L of the N-th layer and the shape of the movement path of the irradiation position of the laser L of the (N+1)-th layer can be made different from each other in the lamination direction. For that reason, the metal layer 10m of high hardness and toughness can be obtained also in the lamination direction by executing the method for manufacturing the three-dimensional shaped object according to this embodiment.

For further details, as illustrated in FIG. 11, in the method for manufacturing the three-dimensional shaped object according to this embodiment, one of the shape of the movement path of the irradiation position of the laser L of the N-th layer and the shape of the movement path of the irradiation position of the laser L of the (N+1)-th layer can be linear and the other can be curved when viewed from the lamination direction. For that reason, by executing the method for manufacturing the three-dimensional shaped object of this embodiment, the shape of the movement path of the irradiation position of the laser L of the N-th layer and the shape of the movement path of the irradiation position of the laser L of the (N+1)-th layer can be made different from each other when viewed from the lamination direction.

The present disclosure is not limited to the embodiments described above, and can be realized with various configurations without departing from the spirit of the present disclosure. The technical features in the embodiments corresponding to the technical features in each aspect described in the summary section of the present disclosure can be appropriately replaced or combined in order to solve part or all of the problems described above or to achieve part or all of the effects described above. If the technical features are not described as essential in the present specification, the technical features can be deleted as appropriate.

What is claimed is:

1. A method for manufacturing a three-dimensional shaped object by laminating a layer to manufacture the three-dimensional shaped object, the method comprising:
a layer forming step of forming the layer using a constituent material containing amorphous metal powder; and
a melting and solidifying step of irradiating the layer with a laser to form a metal layer including plural melted and solidified portions by melting and solidifying the amorphous metal powder, wherein
wherein one of the melted and solidified portion has an overlap region that overlap the another melted and solidified portion, a width of the overlap region is more than half of a width of the melted and solidified portion, and the metal layer has a network of an amorphous region and a crystal region.

2. The method for manufacturing the three-dimensional shaped object according to claim 1, wherein
in the melting and solidifying step, the amorphous metal powder in the layer is continuously melted by that an irradiation position of the laser continuously moves on the surface of the layer.

3. The method for manufacturing the three-dimensional shaped object according to claim 2, wherein
a movement path of the irradiation position of the laser to an N-th layer and a movement path of the irradiation position of the laser to an (N+1)-th layer are different from each other when viewed from a lamination direction.

4. The method for manufacturing the three-dimensional shaped object according to claim 3, wherein
a moving direction of the irradiation position of the laser to the N-th layer and a moving direction of the irradiation position of the laser to the (N+1)-th layer intersect each other when viewed from the lamination direction.

5. The method for manufacturing the three-dimensional shaped object according to claim 3, wherein
a moving direction of the irradiation position of the laser to the N-th layer and a moving direction of the irradiation position to the laser of the (N+1)-th layer are the same direction when viewed from the lamination direction and are shifted by one-half of the width of the melted and solidified portion.

6. The method for manufacturing the three-dimensional shaped object according to claim 3, wherein
a shape of the movement path of the irradiation position of the laser to the N-th layer and a shape of the movement path of the irradiation position of the laser to the (N+1)-th layer are different from each other when viewed from the lamination direction.

7. The method for manufacturing the three-dimensional shaped object according to claim 5, wherein
one of a shape of the movement path of the irradiation position of the laser to the N-th layer and a shape of the movement path of the irradiation position of the laser to the (N+1)-th layer is linear and the other is curved when viewed from the lamination direction.
